(19) United States
(12) Patent Application Publication
(10) Pub. No.: US 2014/0357328 A1
(43) Pub. Date: Dec. 4, 2014

(54) Kick It Phone Stand

(71) Applicant: GADGET EAR TECHNOLOGIES INC., Pompano Beach, FL (US)

(72) Inventors: Rotem Aharon, Coral Springs, FL (US); Usiel Aharon, Pompano Beach, FL (US); Jonathan Fields, Coral Springs, FL (US)

(21) Appl. No.: 14/147,342

(22) Filed: Jan. 3, 2014

Related U.S. Application Data
(60) Provisional application No. 61/829,930, filed on May 31, 2013.

(51) Int. Cl. H04M 1/04

(52) U.S. Cl. CPC H04M 1/04
USPC 455/575.1

(57) ABSTRACT

For the Kick it Phone Stand, we invented a custom click wheel, that makes click sounds and locks the stand securely into five different positions. This allows the phone to be used horizontally and vertically at almost any angle. The Kick it is the only phone stand in the world with a mirror, which is extremely useful for many applications. The mirror sticker can be stuck on the front or back of the kick it leg and easily removed. The stand also works in combination with a separate phone wallet. The Wallet is placed on the phone first, and the Kick it sticks right over it. The Kick it leg can be opened and the thumb can be used to push credit cards in and out of the Wallet, without having to remove the phone stand. When the leg is closed, it conceals your cards and info.

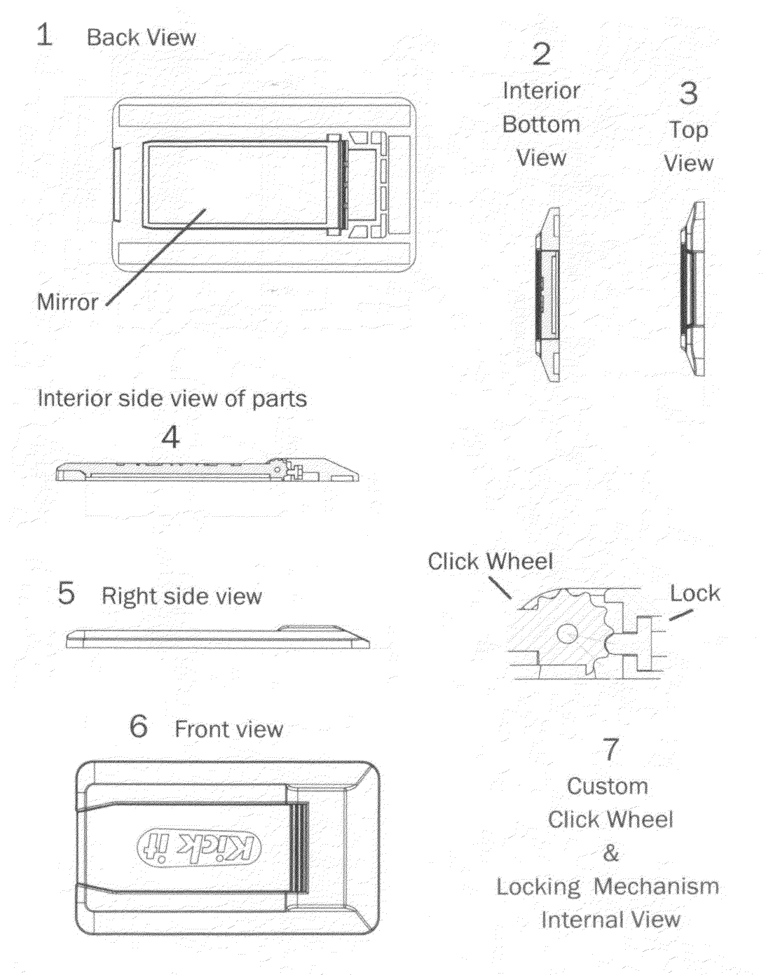

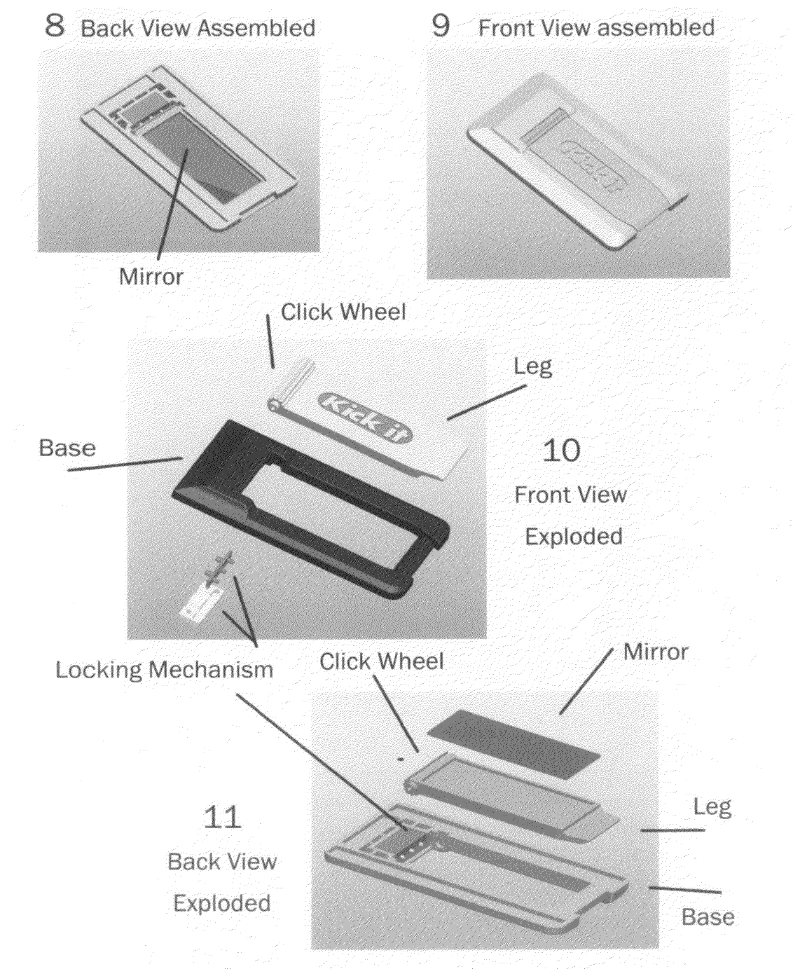

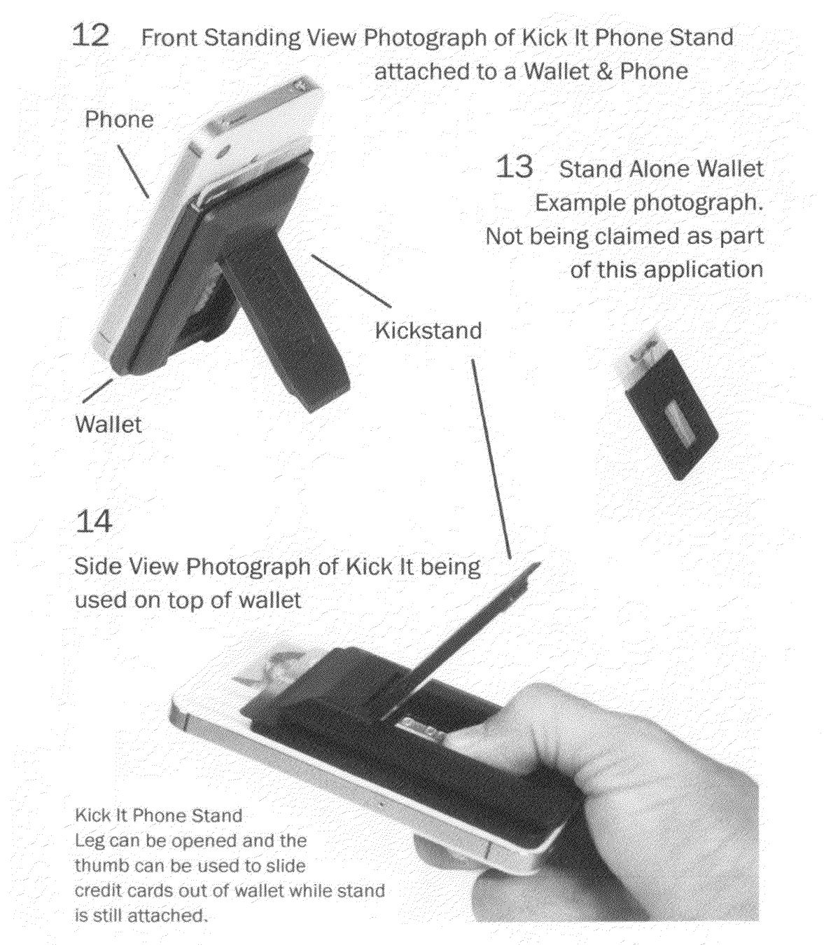

### BACKGROUND OF INVENTION

Inventor, Rotem Aharon, after being sick of always having to hold the phone for personal or business use, came up with the initial concept of the Kick It Phone Stand design. We spent a lot of time doing research to see what other products in the market could fulfill the need. Every other stand had a variety of functionality problems. They were either too big, too small, too bulky, only worked vertical or horizontal, only worked at one vertical angle, would lose stick power or were built in to a phone or case, which makes it impossible to easily switch cases or phones and still have the ability to kick stand the phone. With the fast pace of changing technology and new phones coming out, we knew we had to create something that would be universal and fit almost any phone, regardless of case, make or model. Rotem brought the idea to his father, Usiel Aharon, who then hired engineers to make the initial prototypes for the product. Rotem then brought the prototype to designer Jonathan Fields, who suggested a list of improvements and modifications to improve performance and add some custom features like the mirror and click wheel. After over one year of working and testing 6 different prototypes, we had the final product molded and tooled and began selling the product.

### BRIEF SUMMARY OF INVENTION

The Kick It Phone stand is the most universal and ergonomic phone stand on the market. It is designed to fit almost any phone or case with a flat surface. It can be removed and reused an unlimited amount of times thanks to the polyurethane gel grip pad on the back of the stand. There is a custom click wheel that can lock the stand into 5 different vertical standing positions and also offers 2-3 different horizontal viewing angles. In addition, it is the only phone stand with a mirror and it can be used in combination with a phone wallet, allowing access to credit cards without having to remove the stand.

### DESCRIPTION OF DRAWING VIEWS

1 Back View Black & White Line Drawing with line leading to show mirror placement. Mirror is part of the claim #2.

2 Interior Bottom View Line Drawing

3 Top View Black & White Line Drawing

4 Interior Side View of Parts Line Drawing

5 Right Side View Black & White Line Drawing

6 Front View Black & White Line Drawing

7 Close Up Internal View Line Drawing of Custom Click Wheel & Locking Mechanism with lead lines showing placement of click wheel and lock. Custom Click Wheel & Lock part of claim #1.

8 Back View Assembled 3D Rendering of Kick It with lead line showing mirror placement

9 Front View Assembled 3D Rendering of Kick It Phone Stand

10 Front Exploded View 3D Rendering of Kick It Phone Stand with lead lines showing the different pieces such as leg, base and claim #1 items, Click Wheel and Locking Mechanism.

11 Back Exploded View 3D Rendering of Kick It Phone Stand with lead lines showing the different pieces such as leg, base and claim #1 items, Click Wheel and Locking Mechanism as well as claim #3 item, the mirror.

12 Front Standing View Photograph of Kick It Phone stand attached to Phone Wallet and phone, claim #3. Lead lines showing the separation of the Phone, Wallet and Kick It Phone Stand.

13 Photograph of Front View of a stand-alone phone wallet. No claim is being made to this phone wallet product and these photographs are just being used as an example to show how the wallet can be combined with the Kick It Phone Stand and used simultaneously.

14 Side View Photograph of Kick It Phone stand attached to Phone Wallet and phone, claim #3. Lead line showing the Kick It Phone Stand. This photograph is used to show how the Kick it leg can be opened and used to slide credit cards or identification in and out of a Phone Wallet without having to remove the Kick It Phone Stand. The two can be used simultaneously.

### DETAILED DESCRIPTION OF INVENTION

The Kick It Phone Stand is designed to be the ultimate kick stand that is universal and fits any phone, case or mini-tablet device. The majority of existing phone stands only have two positions, open or closed. The Kick IT has a specially designed click wheel that allows it to operate in over 7 different angles. There 4 open positions and the closed position. This allows the product to be used at many different angles and is a huge improvement over most existing phone stand products. We had the axle designed and custom machined so it can have different clickable stops and made a custom mold for the product. The locking mechanism makes a clicking sound when switching to different positions.

It is also the most ergonomic and thin kickstand that is designed with rounded edges and a sleek profile to stay on your phone while traveling and everyday use. Most other phone stands are bulky and must be removed before placing in a pocket. Or they catch on jeans and pants and make it very difficult to slide in and out of pockets. The Kick It solves this problem. Other stands are mostly used for the home or office or must be carried separately. The Kick It can travel anywhere and becomes one with your phone.

The Kick It is also one of the only phone stands that uses a polyurethane gel grip that can easily be attached and removed from your phone an unlimited amount of times and leaves no sticky residue. Most other products use 3M tape which does not last forever. They can only be used a finite amount of times until the tape gets dirty and loses its stickiness. The Kick It specialty grip pad is made from a polyurethane gel and is embedded in the product, and can be cleaned an unlimited amount of times with just water so it never loses its gripping strength. Thus solving another one of the major problems with existing phone stands.

The Kick It is one of the only stand alone phone stands that works in horizontal and vertical positions. Most other products are either built into the phone or built into the case. Even other stand alone products usually only work in a horizontal or vertical position, not both. This solves the problem of being able to use the stand while texting and emailing in a vertical position and also being able to watch movies in a panoramic view.

The Kick It is the only phone stand that has a mirror built into the product. This can be used to check your teeth after eating, make up for women and even be used for shaving while away from home. The mirror is plastic mirror sticker so it will not easily break and it can be used on the inside or outside of the kickstand leg, depending on the users preference. It can also be removed.

Other useful applications, the kick stand leg can be wedged into the backseat headrest and be used for backseat entertainment, or wedged into an AC vent of a car or wedged into a CD player of a car and be used for navigation.

Kick it is the only phone stand that can fit on top and be used in combination with other phone accessories such as a phone wallet. The stand can be opened and the thumb can be used to slide credits cards in and out of the wallet without having to remove the phone stand.

1. The only multi-click, variable angle phone stand with a custom click wheel that locks into different positions.

2. The only phone stand with a built in mirror

3. The only phone stand that can fit on top and be used in combination with other phone accessories such as a phone wallet
